(19) United States
(12) Patent Application Publication
(10) Pub. No.: US 2014/0057504 A1
(43) Pub. Date: Feb. 27, 2014

(54) AMPHIBIOUS PERSONNEL CARRIER RUNNING ON LAND AND WATER SURFACES

(71) Applicant: Jong Soo LEE, Seoul (KR)

(72) Inventor: Jong Soo LEE, Seoul (KR)

(21) Appl. No.: 13/691,809

(22) Filed: Dec. 2, 2012

(30) Foreign Application Priority Data
Aug. 27, 2012 (KR) 10-2012-0093538

(51) Int. Cl. B60F 3/00

(52) U.S. Cl. CPC B60F 3/0015
USPC 440/12.63

(57) ABSTRACT

The purpose of an embodiment of this invention is, in order to satisfy the requirements for 21st century amphibious landing operations, to develop an amphibious personnel carrier capable of driving faster than 25 Km/hr on the surface of water, executing a seamless transition from sea to land and maneuvering with a mechanized task force for sustained operations ashore. This goal is achieved by the amphibious personnel carrier being composed of 4 front tires and two set of rear tracked belts including six tires configured in a 3×3 arrangement to which the principle of moving on the surface of water depending upon the elevation force being generated over the critical speed is applied, and an engine that can propel the vehicle to run on land and water surfaces with its own traction by the rolling friction over the critical speed.

### CROSS REFERENCE TO RELATED APPLICATIONS

This application is based on and claims priority to Korean Patent Application No. 10-2012-0093538, filed on Aug. 27, 2012, which is incorporated herein by reference in its entirety.

### BACKGROUND

1. Technical Field

Exemplary aspects of the present invention relate to an amphibious personnel carrier which can run on both surfaces of land and water, and can satisfy all the requirements of 21st Century Amphibious Landing Operation.

2. Background Art

The kinds of technologies that are required for an amphibious personnel carrier to perform an Over-The-Horizon Landing Operation in the 21^{st} century are described as follows.

The first is a kind of technology that can speed the vehicle up over 40 Km/hr as an average at the start from a deck of an over-the-horizon carrier ship.

The second is a kind of technology that can execute a seamless transition from sea to land, even with the compositions of tires or tracks capable of speeding at 100 Km/hr on land.

The third is a kind of technology that can maneuver with a mechanized task force for sustained operations ashore.

The requirements of a 21st century landing operation are as follows.

It is a desirable capability that the concerned vehicle can travel at higher speed across far distances over the horizon. Even if the vehicle could not overcome these requirements, the vehicle should independently deliver marine units from the landing carrier ship at least a distance initiating the operation or over the horizon (over 20 Km as its minimum distance) at such a rapid speed that causes a factor of surprise attack on a hostile strengthened shore and could commit ready-to-fight marines into the attack point.

The concerned vehicle enables execution of seamless transit between sea and land and to maneuver the sustained operation together with a mechanized task force on the hostile shore. In order to fulfill these requirements, the speed of the concerned vehicle can be accelerated at least up to 25 Km/hr. However, the speed of the conventional screw propulsion system is limited only to 10 Km/hr.

On the other hand, the amphibious hydro-foil vehicle of U.S. Pat. No. 5,027,737 could, at its underwater mode, covering its track with shoes and lowering a foremost bow flap, speed up faster than 40 Km/hr by operating under the water 2 set of water jets equipped with hydrofoils. This practical model, an expeditionary fighting vehicle, can speed up to 45 Km/hr. This vehicle has drawbacks. The vehicle includes 2,700 HP power for use and during an approach to the hostile shore, require 15 minutes of delay time to wear off the track covers. Accordingly, this vehicle could not fulfill all the requirements of 21st century amphibious landing operations. Thus, the concerning project itself has been abandoned. Accordingly, it may be concluded that the vehicles for 21^{st} century amphibious landing operations cannot be developed only with such conventional hydro-vehicle design factors such as buoyancy, lift and air pressure.

### SUMMARY

An embodiment of the present invention is, after having secured the above three kinds of technologies, to provide an amphibious personnel carrier capable of running on a land surface and a water surface, satisfying a transport mission such that ready-to-fight marine units are rapidly and safely delivered to a hostile shore.

In an exemplary embodiment, an amphibious personnel carrier capable of moving on a water surface includes four front planning tires configured in a 2×2 arrangement and two driving tracked belts in the rear, the driving tracked belts including six tires configured in a 3×3 arrangement.

Since a 21st century amphibious landing operation,(or Over-The-Horizon Landing Operation) should be initiated far, at least over 20 Km, from a hostile shore, all vehicles participating in the concerned operations travel faster than 25 Km/hr starting from a deck of landing carrier ships.

Since a vehicle moving on tires or tracks causes such a severe drag under water, this drag has to be minimized in order for the vehicle to move at higher speed. All of these problems can be solved by enabling the vehicle to run on the surface of water.

Referring to U.S. Pat. No. 8,206,190 B2, herein incorporated by reference in its entirety, it is mentioned that an amphibious fighting vehicle weighing 30 tons can run by its own tracks on the surface of water over the certain critical speed.

An embodiment of the present invention is to apply an ELEVANCY (Elevation Force: a force being generated to support its own weight when a certain object runs on the surface of water over the critical speed) to result in the principle of moving on the surface of water. This principle is applied to the frontal 4 tires for steering and braking and 2 tracked belts including rear 3×3 tires for driving practically to speeds up to 100 Km/hr even on the surface of water. An amphibious personal carrier configured to run on land and water surfaces is capable of executing a seamless transit between surfaces of the sea and land by moving on the tractions of tires and tracks.

### BRIEF DESCRIPTION OF THE DRAWINGS

A more complete appreciation of the disclosure and the aspects, features and advantages thereof will become apparent upon consideration of the following description of the preferred embodiments of the present invention taken in conjunction with the accompanying drawings, wherein:

FIG. 1 is a representative drawing of a first embodiment of an amphibious personnel carrier, over the critical speed that runs on the surface of water with 2×2 planning tires and 2 driving tracked belts.

FIG. 2 is a side view of the first embodiment showing its discrepancy of additional buoyancy on land and sea.

FIG. 3A is a frontal perspective view of the first embodiment, and FIG. 3B is a backward perspective view of the first embodiment.

FIG. 4 is a bottom perspective view of the first embodiment as additional buoyancy is deployed.

FIG. 5 is a conceptual perspective view of the first embodiment's driving train including an engine.

FIG. 6 shows the first embodiment running on the sea surface.

### DETAILED DESCRIPTION

Reference will now be made in detail to exemplary embodiments of the present invention, examples of which are illustrated in the accompanying drawings, wherein like reference numerals refer to the like elements throughout. The exemplary embodiments are described below to explain the present invention by referring to the figures.

As used in the description of this application, the terms “a”, “an” and “the” may refer to one or more than one of an element (e.g., item or act). Similarly, a particular quantity of an element may be described or shown while the actual quantity of the element may differ. The terms “and” and “or” may be used in the conjunctive or disjunctive sense and will generally be understood to be equivalent to “and/or”. References to “an” or “one” embodiment are not necessarily all referring to the same embodiment. Elements from an embodiment may be combined with elements of another. No element used in the description of this application should be construed as critical or essential to the invention unless explicitly described as such. Further, when an element is described as “connected,” “coupled,” or otherwise linked to another element, it may be directly linked to the other element, or intervening elements may be present.

An embodiment of the present invention, an amphibious personnel carrier, is governed by the principle of moving on the surface of water, the elevation force of which is generated over the critical speed. This principle is applied to frontal 4 tires and 2 tracked belts including 6 rear tires configured in a 3×3 arrangement to let the vehicle itself run on the tractions by the rolling friction on the surface of water.

Since the concerned vehicle can run on the sea at speeds of 100 Km/hr which are higher than the speed of 40 Km/hr that is required for 21st century landing operation, the embodiment can not only fulfill the over-the-horizon landing operation but also, on the landing attack, assault the hostile shore with no hesitation. Even at a time of strategic retreat, once the entry onto the sea surface from the land surface occurs over the critical speed, it can at once accelerate right on the sea surface to the highest speed so as to provide safe retreat. After having landed on the hostile shore, the vehicle can suppress the enemy with equipped firepower. And then, ready-to-fight marine units can be deployed. Also, the vehicle can maneuver with a mechanized task force to carry out an inland assault operation in parallel.

At first, an embodiment of the present invention should be provided with such a capability that it can execute over-the-horizon landing operation as a concept of 21st amphibious landing operation.

To do this, the principle of moving on the surface of water, the elevation force of which is generated over the critical speed, should be applied to an embodiment of the present invention. This principle is governed by Lee Number “LN” as being described in the following.

$${L}_{N} = \frac{{V}_{C}}{g \times Δ T} \qquad ( Eq . 1 )$$

wherein “V_{C}” is the critical speed, “g” is the gravitational acceleration and “ΔT” is the critical instant of stay.

The above principle is applied to the tracked belts including tires of radius “R” to result in the following relationship.

$${V}_{C } = \frac{π R}{Δ T} \qquad ( Eq . 2 )$$

From Eq. 1 and Eq. 2, the tire radius “R” of the concerned vehicle can be calculated to obtain the corresponding critical speed “V_{C}”. Then, the length of tracks and the dimensions of the cleats can be determined to arrive at the concerned critical speed.

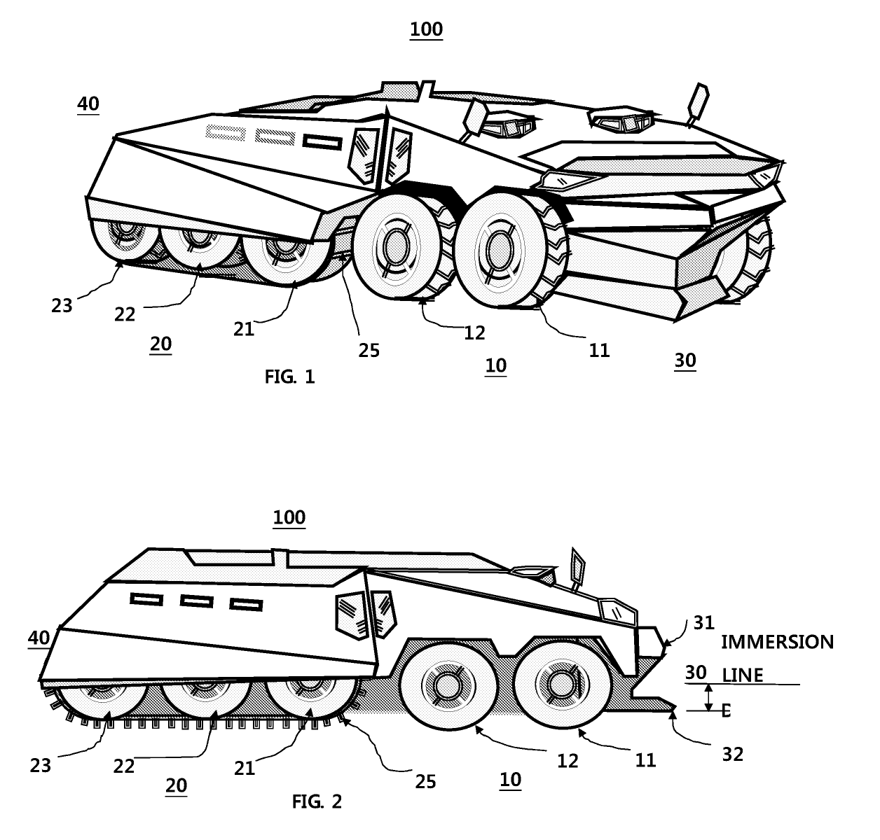

FIG. 1 presents a view of a first embodiment. An amphibious personnel carrier (100) running on water and land surfaces includes 4 tires (10) which are represented as (11) and (12) on the frontal one side and the tracked belt (20) in the rear wherein 3 set of tires (21) (22) and (23) together with cleats (25) are shown. An aspect of the bellows (30) provides an initial buoyancy for the front part of the vehicle and the skirt (40) provides another initial buoyancy for the rear part of the vehicle as shown in FIG. 1.

FIG. 2 is a side perspective view of the first embodiment (100). The radius “R” of tires (21), (22) or (23) included in the tracked belts (20) is obtained in order for the exemplary embodiment to be capable of running on the surface of water over the critical speed. And the embodiment may accelerate under or in the water to the corresponding critical speed to emerge from the water to the surface. To accomplish this, the depth and number of the cleats (25) on the tracked belts (20) can be calculated from the following relationship.

P_{C}=2×(½×ρ_{w}N A_{C}×V_{C}²×C_{D}) (Eq. 3)

wherein
P_{C}: Vehicle's propulsion (W) at the critical speed;
ρ_{w}: Density of sea water (1,000 Kg/m3);
A_{C}: Unit area of cleat;
N: Number of cleat on the tracked belts contacted to the sea surface;
V_{C}: The critical speed of the concerned vehicle on sea; and
C_{D}: Drag coefficient (1.7) in the sea depending upon the cleat shape.

The principle of moving on the surface of water is applied to the front tires configured in the 2×2 arrangement (10) [(11) and (12)], which results in the identical radius “R”. The corresponding critical speed can be obtained by the following equation.

V_{C}=\sqrt{g×R} (Eq. 4)

The critical speed obtained above can be compared with the other for the rear tracked belts by applying Eq. 2.

The critical speed for the front tires is lower than the one for the rear tracked belts. This means that the front tires (10) will rise to the water surface earlier than the rear tracked belts (20) do.

Also, FIG. 2 shows bellows (30) in the front part and skirt (40) in the rear part as the initial buoyancies assisting the immersion line of the vehicle to be positioned lower than the shaft line of tires. These initial buoyancies help the vehicle to smoothly rise to the surface of water over the critical speed. When moving from sea to land, the shoe (32) of bellows can be lifted to the depth “D” for its free operation on land. When the vehicle (100) is running through higher waves, it can wade through the incoming waves with a float fender (31) which prevents the vehicle from going under. Thus, the present embodiment is capable of performing smooth landing operations.

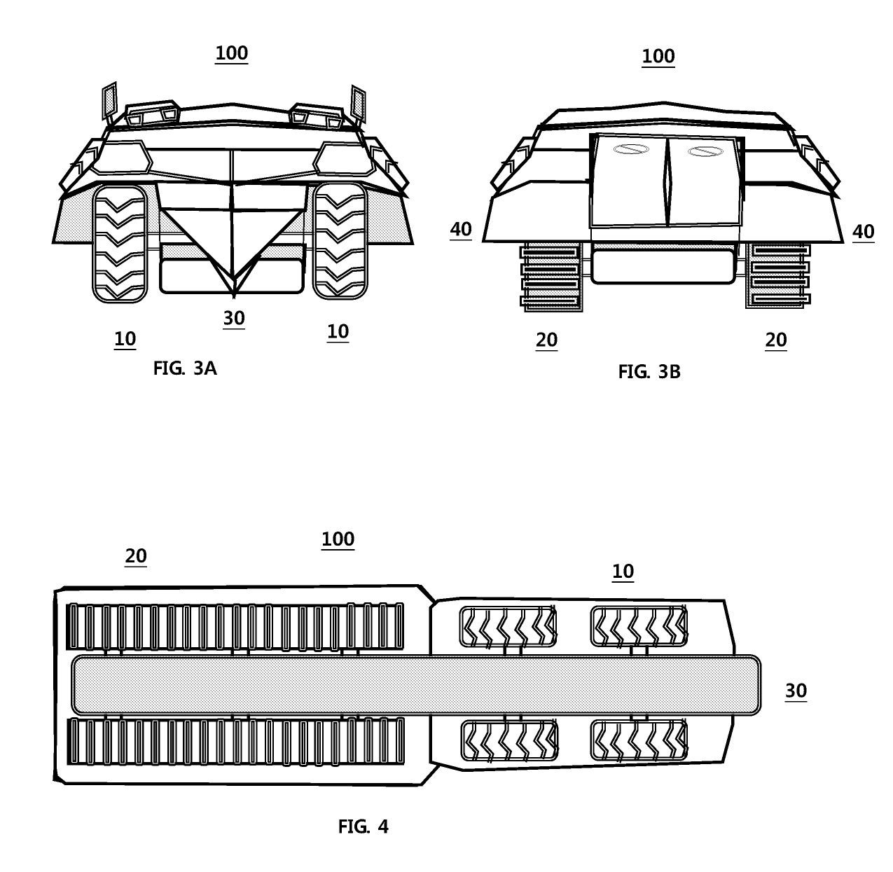

FIG. 3A is a frontal perspective view of the present embodiment (100), which shows a lower silhouette than the double height of frontal tires (10). It also shows that the additional buoyancy bellows (30) under the vehicle is deployed down to a bottom face of tires (10). FIG. 3B—rear is a rear perspective view of the present embodiment (100), which shows the skirt (40) as rear additional buoyancy to be exposed outside of the rear tracked belt (20).

FIG. 4 is a bottom perspective view of the present embodiment (100), which shows four front tires configured in the 2×2 arrangement (10), 2 rows of tracked belts (20) including the six rear tires configured in the 3×3 arrangement, and the initial add-on of buoyant bellows (30).

With this configuration, the buoyant volume below the immersion line of the vehicle, which can charge the initial buoyancy being required for the vehicle's rise to the water surface over its critical speed, can be estimated.

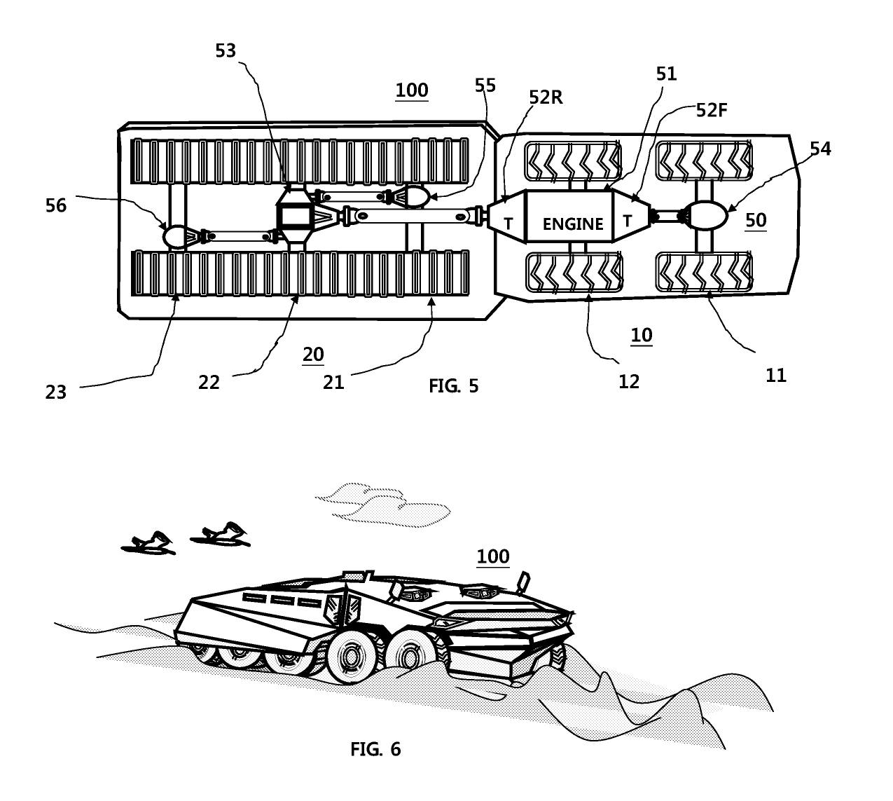

FIG. 5 shows the operating train (50) of the first embodiment (100), which is driving the frontal tire section (10) including the four front tires configured in the 2×2 arrangement (11) and (12) in the front and 2 sets of tracked belts including the six tires configured in the 3×3 arrangement (21), (22) and (23) in the rear, and in which, with an engine (51), the frontal tire section (10) is driven by a differential gear box (54) through frontal and rear transmissions (52F) and (52R) and, in the rear, the tire (21) is driven by a differential gear box (55) and the tire (23) is also driven by a differential gear box (56), both through a transfer box (53) mounted on the tire (22).

The required power for the concerned engine(51) is such a case that the first embodiment (100) is running on the surface of water with the highest speed of 100 Km/hr being required for 21st century landing operation and can be obtained by the following equation.

$$HP = \frac{[ {C}_{RR} \times W \times {V}_{Max} + \frac{1}{2} {ρ}_{Air} \times {A}_{P} \times {V}_{Max}^{3} \times {C}_{D} ]}{η \times 750} \qquad ( Eq . 5 )$$

wherein
HP: Required horse power;
C_{RR}: Rolling resistance coefficient (0.05);
W: Vehicle's weight (13 ton);
V_{Max}: Vehicle's maximum speed on the water surface (100 Km/hr);
ρ_{Air}: Air density on the sea (1.22 Kg/m3);
A_{F}: Frontal area of the vehicle;
C_{D}: Ambient drag coefficient on the water surface (1.0); and
η: Vehicle's engine efficiency (0.85).

FIG. 6 shows such an aspect that the present embodiment (100) is running at the maximum speed of 100 Km/hr together with frigate-birds flying over the sea.

With a reference to the above practices and attached drawings, Exemplary specifications of an embodiment fulfilling all the requirements, being capable of participating in 21st amphibious landing operation so called over-the-horizon landing operation are described in the following table.

| Specification | Unit | | Remark |
|---|---|---|---|
| Weight | 13,000 | Kg | Full Equipped Marine Squad Incl. |
| Power | 420 | HP | Water |
| Contact Pressure | 0.58 | Kg/cm² | Amphibious |
| Land Max/Cruise | 100/65 | Km/hr | Pavement |
| Water | 100/75 | Km/hr | Level 2 |
| Max/Cruise | | | |
| Critical Speed | 14.1 | Km/hr | On Water |

| | | |
|---|---|---|
| No of Tire | 10 {2 × (2 + 3)} | Aircraft Quality (Φ1,000 mm) |

Although embodiments of the present invention have been shown and described, it would be appreciated by those skilled in the art that changes may be made in these embodiments without departing from the principles and spirit of the invention, the scope of which is defined in the claims and their equivalents.

What is claimed is:

1. An amphibious personnel carrier configured to run on land and water surfaces, comprising:
a bellows configured to provide initial buoyancy for a front part of the amphibious personal carrier;
a skirt configured to provide initial buoyancy for a rear part of the amphibious personal carrier;
four front tires configured in a 2×2 arrangement;
rear tracked belts including six tires configured in a 3×3 arrangement, being configured with viable height and width; and
an engine generating such an output that the amphibious personnel carrier can run on a surface of water over a critical speed.

2. The amphibious personnel carrier configured to run on water and land surfaces of claim 1,
wherein an immersion line of the amphibious personal carrier in water under the critical speed is located under a center of a tire shaft by providing the skirt toward the rear part of tracked belts and the bellows in order to control a bottom height of the amphibious personal carrier.

3. The amphibious personnel carrier configured to run on water and land surfaces of claim 1, further comprising:
a float fender configured to oppose incoming waves.

4. The amphibious personnel carrier configured to run on water and land surfaces of claim 1,
wherein the tracked belts comprise cleats which are designed with certain height and width in order to go faster than the critical speed in water.

5. The amphibious personnel carrier configured to run on water and land surfaces of claim 1, further comprising:
driving drive train system, comprising;
the engine;
a front transmission and a rear transmission;
a transfer box; and
3 differential gear boxes.

6. An amphibious personnel carrier configured to run on land and water surfaces, comprising:
a hybrid system, comprising:
frontal tires; and
rear tracked belts,
wherein a principle of moving on a surface of water is applied to the amphibious personal carrier so that the amphibious personal carrier is configured to run on the surface of water over a critical speed depending upon an elevation force.

7. The amphibious personnel carrier configured to run on land and water surfaces of claim 6,
wherein the principle of moving on the surface of water is governed by Lee number
$$[ {Le}_{N} = \frac{{V}_{C}}{g \times Δ T} \text{:} \frac{Critical Speed}{Gravitational Acceleration \times Critical Instant of Stay} ] .$$
